(19) United States
(12) Patent Application Publication
(10) Pub. No.: US 2019/0204997 A1
(43) Pub. Date: Jul. 4, 2019

(54) Method And Device For Operating An Electronic Appliance

(71) Applicant: CONTINENTAL AUTOMOTIVE GmbH, Hannover (DE)

(72) Inventor: Ercan TUNCA, Rüsselsheim (DE)

(21) Appl. No.: 16/329,159

(22) PCT Filed: Aug. 21, 2017
(86) PCT No.: PCT/EP2017/071001

§ 371 Date: Feb. 27, 2019

(30) Foreign Application Priority Data
Aug. 30, 2016 (DE) 10 2016 216 318.3

(51) Int. Cl. G06F 3/0482; G06F 3/16; G06F 3/0488

(52) U.S. Cl. CPC G06F 3/0482; G06F 3/167; B60K 37/06; G06F 2203/04808; G06F 3/04883

(57) ABSTRACT

A method for preselecting and/or selecting a menu, a submenu, a function, or a function value of an electronic device. The menu, the submenu, the function, or the function value is preselectable and/or selectable using a touchpad with a first body part and an audible feedback is output table. The audible feedback is activated by an additional touch of the touchpad at any point with a second body part.

### CROSS REFERENCE TO RELATED APPLICATIONS

This is a U.S. national stage of application No. PCT/EP2017/071001, filed on Aug. 21, 2017. Priority is claimed on German Application No. DE102016216318.3, filed Aug. 30, 2016, the content of which is incorporated herein by reference.

### BACKGROUND OF THE INVENTION

### 1. Field of the Invention

The invention relates to a method and an apparatus for operating an electronic device.

### 2. Description of the Prior Art

Methods are known from the prior art for preselecting and/or selecting a menu, a submenu, a function or a function value of an electronic device, the menu, the submenu, the function or the function value being preselectable and/or selectable by a touch of a touchpad with a first body part and an audible feedback being outputtable for the preselected and/or selected menu, submenu, function value or the preselected and/or selected function of the electronic device. The selecting of the menu, the submenu, the function or the function value is accomplished, for example, by touching that point on the touchpad, which is associated with the menu, the submenu, the function or the function value. These points can be denoted visually, for example, by printing or a presentation on a display. It is also conceivable, however, for nothing to be presented on the touchpad to force the operator to operate blind and to prevent him from looking at the touchpad during operation. The selection of the menu, the submenu, the function or the function value can be accomplished by a second action such as, for example, a brief raising and lowering of the first body part onto the touchpad. There are also other conceivable selection options, however, such as, for example, operating an additional switch or keeping the first body part on the touchpad for a longer time after termination of the audible feedback. The output of an audible feedback is particularly useful if the operator of the electronic device should not be distracted by looking at the user apparatus. The distraction can occur, for example, when the electronic device is arranged in a vehicle and the operator simultaneously needs to attend to the steering of the vehicle and therefore should not actually look at the user apparatus. Therefore, it is known practice in the prior art to provide the operator of an electronic device in motor vehicles with an audible feedback when he carries out a method for preselecting and/or selecting a menu, a submenu, a function or a function value of an electronic device, the menu, the submenu, the function or the function value being preselectable and/or selectable by a touch of a touchpad with a first body part. The audible feedback can be provided automatically. A disadvantage of this is that the automatic feedback can overwhelm or distract the operator of the electronic device, since possibly multiple audible feedbacks can be delivered that possibly likewise distract or overwhelm the operator. Therefore, it is known practice in the prior art to start an audible feedback by operating a switch. This can be arranged, for example in a motor vehicle, on the steering wheel or below the steering wheel of the motor vehicle. This has the disadvantage that, in addition to the hand that touches the touchpad, the second hand of the driver is needed. As a result, secure holding of the steering wheel by the second hand can be impaired. As a result of this configuration, the driver is additionally distracted more than necessary from his actual driving task, since he needs both hands for operating the electronic device. Furthermore, it is known practice to output an audible feedback when the body part does not change its position on the input surface for a minimum time. This has the disadvantage that the audible feedback can be triggered unintentionally. Finally, it is also known practice to trigger an audible feedback by voice recognition. However, this voice recognition cannot always be reliably detected because of the noise occurring in the motor vehicle.

### SUMMARY OF THE INVENTION

An object of one aspect of the invention is to specify a method and a user apparatus for operating an electronic device which does not distract the operator beyond measure and thus, for example, increases driving safety during operation of the electronic device inside motor vehicles as a result of the complexity of operation being reduced for input devices with touchpads.

This object is achieved in that the method involves the audible feedback being activated by an additional touch of the touchpad at any point with a second body part, and the user apparatus is configured such that the audible feedback is activable by an additional touch of the touchpad at any point with a second body part. As a result, the audible feedback can be triggered without increased attention by the operator.

By applying and dragging a third body part, a function value can be simply increased or decreased. For example, a function value can be decreased when the third body part is moved in the direction of the first and/or second body part. This association is particularly intuitive, since the distance of the body parts from one another is also decreased. A totally different association is also possible, however, by dragging the third body part away from the first and/or second body part, a function value can be increased accordingly.

Parts of a hand, such as, for example, the individual fingers for the first body parts, are preferred as body parts for touching the touchpad, since the fingers have only a small contact area on the touchpad in relation to the touchpad and thus a multiplicity of different menus, submenus, functions, and/or function values are presented on the touchpad at the same time and can be associated with a position on the touchpad and as such can be preselected and/or selected without switching over. The second body part used can also be a finger of a hand, for example. However, it is also possible to touch the touchpad with the heel of the hand or an edge of the hand and thus trigger the audible feedback. Thus, in a first exemplary embodiment, the touchpad can be touched with an index finger of a hand as the first body part, the audible feedback can be triggered by the heel of the hand, and a function value preselected by the index finger can be increased and/or decreased by the thumb of the hand being dragged over the touchpad. The third body parts used can also be other fingers of the hand. The method may be configured such that the touch of the touchpad is governed only by the order of the touches and not by the size of the body parts used, so that an operator can decide for himself which body parts he uses to touch and operate the touchpad.

If the first and second body parts need to touch the touchpad adjacently, inadvertent incorrect operation can be precluded.

The touchpad can have an optical, capacitive, or resistive touch detection.

If the touchpad has a display and is therefore configured as a touchscreen, it is also possible for different menus, submenus, functions, and/or function values to be presented on the display in succession and thus for the number of preselectable and/or selectable menus, submenus, functions, and/or function values to be increased in comparison with a pure touchpad without a display. The display is preferably designed as an electro-optical display, such as, for example, as an LCD, LED display or OLED display, since these displays are durable and inexpensive to procure.

### BRIEF DESCRIPTION OF THE DRAWINGS

The invention will be explained in more detail below on the basis of the figures, in which:

FIG. 1 is a touchpad with a first presentation of selectable menus;

FIG. 2 is the touchpad from FIG. 1 with a second presentation of menus;

FIG. 3 is the touchpad from the preceding figures with a presentation of submenus;

FIG. 4 is the touchpad from the preceding figures with a presentation of an adjustable function value;

FIG. 5 is the touchpad from the preceding figures with a presentation of a station selection with an applied finger of a hand; and

FIG. 6 is the touchpad from the preceding figures with a presentation of the hand from FIG. 5 with two applied fingers.

### DETAILED DESCRIPTION OF THE PRESENTLY PREFERRED EMBODIMENTS

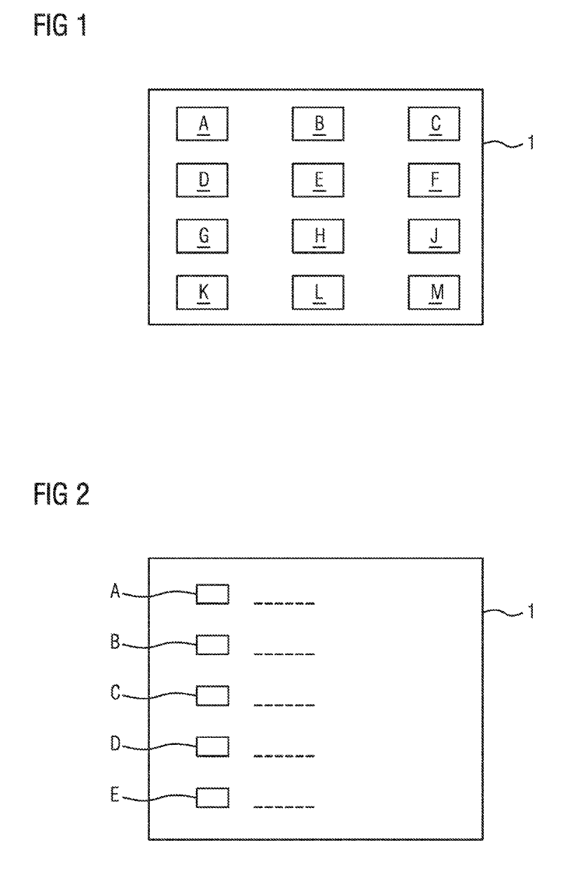

FIG. 1 shows a touchpad 1 with a menu with preselectable and selectable sub-menus A-M. If the touchpad 1 is touched in the region of the respective submenu with a body part, for example a first finger of a hand, the corresponding submenu is preselected and can be selected by a second action. By applying a second body part, for example a second finger of the hand, the heel of the hand or the side of the hand, it is possible for the audible feedback to be activated.

The second action for selecting the preselected submenu may be, for example, briefly raising the first finger and retouching the touchpad 1, leaving the first body part in place for a certain period of time after touching the touchpad or activating the audible feedback, or any other assigned action, such as, for example, applying a third body part while the first and second body parts continue to touch the touchpad, or operating a switch.

The touchpad 1 can be designed so that the preselectable menus are presented permanently, for example by printing, painting or engraving the surface of the touchpad. It is then only possible to select from the presented menu, however. Furthermore, it is possible to present nothing on the surface and thus to force the operator to operate blind. Finally, it is possible for the touchpad to be designed as a touchscreen and thus to present the preselectable and selectable menus, submenus, functions, and function values in the form of symbols and/or text information depending on the status of the operating system.

FIG. 2 shows the preselectable submenus A-E in a second arrangement on the touchpad 1. Otherwise, there is no difference from the touchpad in FIG. 1.

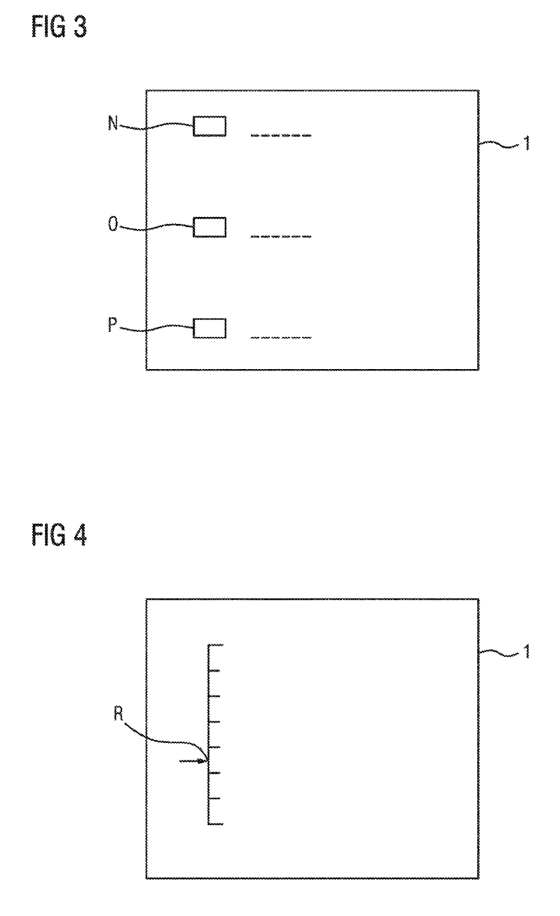

FIG. 3 shows three submenus N-P on the touchpad 1, said submenus being preselectable and selectable by selecting menu A from FIG. 1 or 2, for example. These subfunctions are also denoted by text information or symbols indicated in FIG. 3. The submenus can relate to functions of a radio receiver, for example, such as volume setting, station selection, and balance.

If submenu N is the volume setting, for example, then, after selecting this submenu on the touchpad 1, the volume setting is presented, as shown in FIG. 4. The volume can be changed by touching an arrow R with a body part and moving the body part on the display, for example. However, it is also possible for example to touch the touchpad 1 with a third body part while the first and second body parts continue to touch the touchpad, and to increase or decrease the distance between the first and third body parts. It is thus possible, for example, for the touchpad 1 to be touched with an index finger of one hand and the heel of the hand and at the same time for the touchpad 1 to be touched with the thumb or middle finger of the hand and for the distance between the index finger and thumb or middle finger to be increased or decreased and thus for the volume to be changed accordingly.

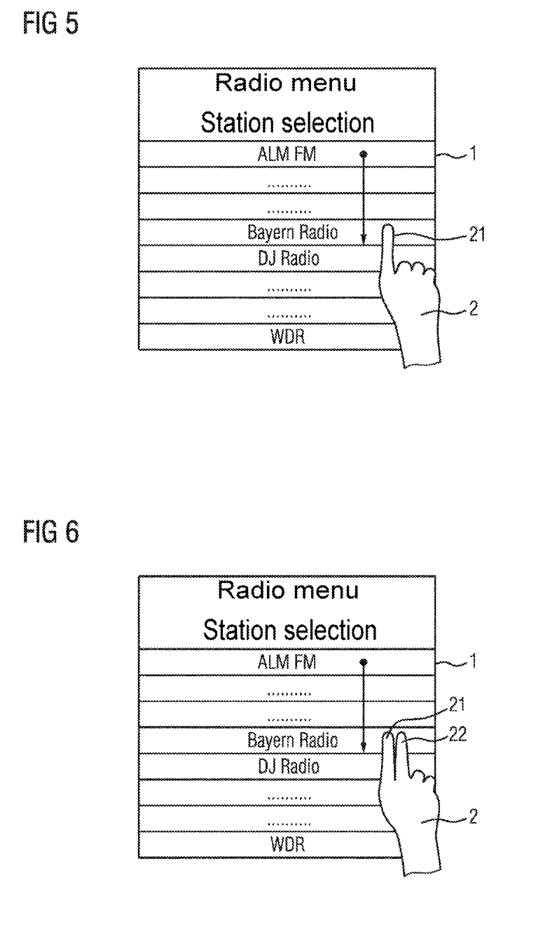

FIG. 5 shows the touchpad 1 configured as a touchscreen, on which a station selection menu is presented, and a hand 2 of an operator, who is otherwise not shown, with an index finger 21. The index finger 21 touches the touchpad in the region that is assigned for the preselection and selection of the station “Bayern Radio”. If a further body part, such as, for example, a middle finger 22 as shown in FIG. 6, now touches the touchpad 1, the audible feedback output is the spoken information such as, for example: “Bayern Radio” or “You have preselected the station Bayern Radio”. The preselected station can then be selected, for example, by applying a third body part such as, for example, the heel of the hand 2 or the thumb of the hand 2.

It is possible to allow only certain body parts or modes of action for the selection, or to focus only on the number of body parts applied. It is also possible for the selection to be provided for alternatively or additionally by another action such as, for example, the brief lifting of the first body part, the index finger 21 in the exemplary embodiment shown in FIGS. 5 and 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for preselecting and/or selecting at least one of a menu, a submenu, a function, and a function value of an electronic device, comprising:
touching a touchpad of the electronic device with a first body part to at least one of preselect and select the menu, the submenu, the function, or the function value; and
activating an audible feedback by an additional touch of the touchpad at any point with a second body part; and
outputting the audible feedback for the at least one of preselected and selected menu, submenu, function value, or function of the electronic device.

19. The method as claimed in claim 18, further comprising:
applying and dragging of a third body part to alter a preselected or selected function value.

20. The method as claimed in claim 18, wherein each of the menu, the submenu, the function, and the function value is associated with a position on the touchpad.

21. The method as claimed in claim 20, wherein each of the menu, the submenu, the function, and the function value is preselectable and/or selectable by a touch of the associated position.

22. The method as claimed in claim 18, wherein the first body part is a first finger.

23. The method as claimed in claim 22, wherein the second body part is a second finger.

24. The method as claimed in claim 23, wherein the first and second fingers touch the touchpad adjacently.

25. A user apparatus configured for preselecting and/or selecting at least one of a menu, a submenu, a function or a function value of an electronic device, comprising:
a touchpad configured to be touched of with a first body part to preselect and/or select the menu, the submenu, the function or the function value; and
an output for an audible feedback for the preselected and/or selected menu, submenu, function value or the preselected and/or selected function of the electronic device, wherein the audible feedback is activable by an additional touch of the touchpad at any point with a second body part.

26. The user apparatus as claimed in claim 25, wherein the applying and dragging of a third body part is usable to alter a function value.

27. The user apparatus as claimed in claim 25, wherein the menu, the submenu, the function or the function value is associated with a position on the touchpad.

28. The user apparatus as claimed in claim 27, wherein the preselectable and/or selectable menu, the preselectable and/or selectable submenu, the preselectable and/or selectable function or the preselectable and/or selectable function value is preselectable and/or selectable by a touch of the associated position.

29. The user apparatus as claimed in claim 25, wherein the first body part is a first finger.

30. The user apparatus as claimed in claim 29, wherein the second body part is a second finger.

31. The user apparatus as claimed in claim 30, wherein the audible feedback is activatable by a touch of the touchpad when the first and second fingers touch the touchpad adjacently.

32. The user apparatus as claimed in claim 25, wherein the touchpad has a capacitive, inductive, resistive, or optical touch detection.

33. The user apparatus as claimed in claim 25, wherein the touchpad is a touchscreen.

34. The user apparatus as claimed in claim 33, wherein the touchscreen has an electro-optical display.
